(19) United States
(12) Patent Application Publication
(10) Pub. No.: US 2011/0243008 A1
(43) Pub. Date: Oct. 6, 2011

(54) COMPONENT CARRIER ACTIVATION METHOD AND APPARATUS IN A CELLULAR COMMUNICATION SYSTEM

(75) Inventors: Young Bum KIM, Seoul (KR); Soeng Hun KIM, Suwon-si (KR); Joon Young CHO, Suwon-si (KR); Jin kyu HAN, Seoul (KR); Seung Hoon CHOI, Suwon-si (KR); Hyung Ju JI, Seoul (KR)

(73) Assignee: Samsung Electronics Co., Ltd., Suwon-si (KR)

(21) Appl. No.: 13/075,811

(22) Filed: Mar. 30, 2011

(30) Foreign Application Priority Data
Mar. 30, 2010 (KR) 10-2010-0028740

(51) Int. Cl. H04W 24/00

(52) U.S. Cl. 370/252; 370/329

(57) ABSTRACT

A method and apparatus for activating a deactivated Component Carrier in a cellular communication system supporting carrier aggregation. The method includes receiving, from a Base Station (BS), UpLink (UL) scheduling information for a UL CC in a deactivated state; determining whether a DownLink (DL) CC associated with the UL CC is activated; and activating the DL CC, when the DL CC is not activated.

### PRIORITY

This application claims priority under 35 U.S.C. §119(a) to Korean Patent Application No. 10-2010-0028740, which was filed in the Korean Intellectual Property Office on Mar. 30, 2010, the entire disclosures of which are hereby incorporated by reference.

### BACKGROUND OF THE INVENTION

1. Field of the Invention

The present invention relates generally to a cellular communication system and, in particular, to a method and apparatus for activating a deactivated component carrier in a cellular communication system supporting carrier aggregation.

2. Description of the Related Art

Researches is currently being conducted Orthogonal Frequency Division Multiple Access (OFDMA) and Single Carrier-Frequency Division multiple Access (SC-FDMA) in the cellular communication field. This type of multiple access technology is used to allocate and manage the time-frequency resources for data and/or control information transmission to and from multiple users without overlapping with each other, i.e., orthogonally, so as to discriminate among the user.

One of the significant features of the cellular communication system is to support scalable bandwidth for providing high speed data service. For example, a Long Term Evolution (LTE) system can support various bandwidths, e.g., 20/15/5/3/1.4 Mhz. The mobile carriers can provide their services by selecting one of the available bandwidths, and the User Equipments (UEs) have various capabilities from a minimum 1.4 MHz bandwidth up to 20 MHz bandwidth. Further, an LTE-Advanced (LTE-A) system designed to meet the performance requirements of International Mobile Telecommunications (IMT)-2000-Advanced can support high data rate transmission over a wide bandwidth up to 100 MHz for a single UE with a carrier aggregation technique.

In order to support the high data rate transmission, the LTE-A system requires the bandwidth wider than that of the LTE system while preserving backward compatibility to the legacy systems for supporting the LTE UEs. In order to provide the backward compatibility, the system bandwidth of the LTE-A system is divided into a plurality of subbands or Component Carriers (CC) that can be used for the transmission/reception of the LTE UEs and aggregated for the high data rate transmission of the LTE-A system with the transmission/reception process of the legacy LTE system per CC.

FIG. 1 is a block diagram illustrating carrier aggregation of UpLink (UL) and DownLink (DL) CCs for an LTE-A system.

Herein, the term “UL” refers to a radio link for transmitting data or a control signal from a UE to an evolved Node B (eNB), and the term “DL” refers to a radio link for transmitting data or a control signal from the eNB to the UE. A reference CC among a plurality of CCs is referred to as a primary carrier, Primary Component Carrier (PCC), or anchor CC. CCs, except for the primary carrier, are referred to as secondary carriers, secondary (SCCs), or non-anchor CCs. The eNB (or Base Station (BS)) notifies the UE (or Mobile Station (MS)) of the primary carrier via BS signaling. Typically, it is assumed that the number of CCs to be aggregated is configured by higher layer signaling.

For DL, the initial system information or higher layer signaling is transmitted over the primary carrier, e.g., a reference CC for controlling mobility of the UE. For UL, the component subcarrier for transmitting the control channel including Hybrid Automatic Repeat reQuest-ACKnowledgement (HARQ-ACK) or Channel Quality Indicator (CQI) of the UE can be the UL primary carrier.

Referring to FIG. 1, three DL CCs are aggregated with the DL primary CC1 and three UL CCs are aggregated with the UL primary CC1. Although symmetric carrier aggregation is illustrated as an example in FIG. 1, the UL and DL CCs can be configured in asymmetric carrier aggregation in which the number of UL CCs differs from that of DL CCs.

As described above, the LTE-A system allows CC-specific data transmission. The scheduling information for the data transmission per CC is transmitted to the UE in the form of DL Control Information (DCI). Various DCI formats are defined for UL or DL data scheduling information, compact DCI for small amounts of control information, spatial multiplexing with multiple antennas, and power control indication. For example, the DCI format 0 for an UL grant includes the following control information:
DCI format 0/1A flag: 1-bit flag for differentiating DCI format 0 and DCI format 1A. Because the DCI format 0 is identical to the DCI format 1A in an amount of control information, the two DCI formats are differentiated with the DCI format 1/1A flag. The DCI format 1A is used for the compact scheduling of one Physical DL Control Channel (PDCCH) and has a small amount of control information when compared to the DCI format 1, which carries different scheduling control information.
Frequency hopping flag: 1-bit flag to indicate whether the frequency hopping is applied for Physical UL Shared Channel (PUSCH) as UL data channel.
Resource block assignment: to indicate Resource Block (RB) assigned for data transmission. Its size is determined depending on system bandwidth.
Modulation and Coding Scheme (MCS): to indicate modulation scheme and coding rate for data transmission and transport block size.
New Data Indicator: to indicate HARQ initial transmission or retransmission.
Transmit Power Control (TPC) command for PUSCH: to indicate TPC for PUSCH.
Cyclic shift for DeModulation Reference Signal (DM RS): to indicate cyclic shift value of UL DM RS necessary for PUSCH demodulation.
CQI request: to request the UE for measuring and transmitting CQI. The CQI is represented by MCS referenced when an eNB transmits DL data.

The DCI is transmitted on the PDCCH after being channel coded and modulated.

FIG. 2 is a diagram illustrating UL data transmission scheduling in an LTE-A system supporting aggregation of two CCs in both UL and DL.

Referring to FIG. 2, a DCI 209 to be transmitted on a DL CC1 (DL CC1) 201 is formatted as defined in a legacy LTE, channel-coded, and then interleaved into PDCCH 211. The PDCCH 211 is transmitted in up to a first three of OFDM symbols of a subframe as a basic transmission unit of data or control information as spread in a frequency domain, and the resource amount for the PDCCH transmission varies according to channel conditions of a UE.

In the legacy LTE and LTE-A systems, a subframe is 1 ms long. If the PDCCH 211 is transmitted in n^{th} subframe of DL CC1 201, the UE transmits data through the PUSCH 213, which is an UL data channel, in (n+4)^{th} subframe on the UL CC1 203. The time interval between subframes carrying the PDCCH 211 and PUSCH 213 is configured to a fixed value of 4 subframes in consideration of the signal processing time of the UE and HARQ timing.

A DCI 215 to be transmitted on a DL CC2 205 is formatted as defined in the legacy LTE, channel-coded, and then interleaved into a PDCCH 217. If the PDCCH 217 is transmitted in n^{th} subframe of DL CC2 205, the UE transmits the data through a PUSCH 219 in an (n+4)^{th} subframe of an UL CC2 207. In FIG. 2, because the UE cannot predict the time when the eNB schedules the PUSCH transmissions 213 and 219 on the UL CC1 203 or UL CC2 207, it continuously attempts decoding the PDCCH 211 on the DL CC1 201 and the PDCCH 217 on the DL CC2 205. That is, without awareness of whether the eNB transmits a PDCCH, the UE monitors the DL CC1 201 and DL CC2 205 to receive a PDCCH, resulting in increased power consumption.

FIG. 3 is a diagram illustrating another exemplary case of scheduling UL data transmission in the LTE-A system supporting aggregation of two CCs in both UL and DL.

FIG. 3 is a diagram illustrating a UL data transmission scheduling in an LTE-A system supporting aggregation of two CCs in both UL and DL.

Referring to FIG. 3, a DCI for the data transmission on the UL CC2 307 is transmitted on the DL CC2 305 due to the excessive DL interference of the DL CC2 305 as compared to the DL CC1 301, such that a predetermined DCI reception performance requirement is not fulfilled. In this case, the eNB can transmit the DCI for data transmission on the UL CC2 307 through the DL CC1 301.

In order to operate as described above, the eNB transmits a Carrier Indicator (CI) for indicating the CC on which the DCI is sent along with the DCI including the resource allocation information and transmission type of the scheduled data. For example, CI=‘00’ indicates the scheduling information of the UL CC1 303, and CI=‘01’ indicates the scheduling information of the UL CC2 307.

The eNB combines the DCI having the resource allocation information and transmission type of the PUSCH 315 scheduled on the UL CC1 303 with the CI to configure an extended DCI 309, performs channel coding, modulation, and interleaving on the extended DCI 309 so as to be mapped in the PDCCH region, resulting in a transmission in an n^{th} subframe. If the extended DCI 309 for scheduling the PUSCH 315 of UL CC1 303 is received, the UE transmit the PUSCH 315 in an (n+1)^{th} subframe on the UL CC1 303.

Simultaneously, the eNB combines the DCI containing the resource allocation information and transmission type of the PUSCH 317 scheduled on the UL CC2 307 and the CI into an extended DCI 311, performs channel-coding, modulation, and interleaving on the extended DCI 311 to configure the PDCCH 313, and maps the PDCCH 313 to the PDCCH region of the DL CC1 301. If the extended DCI 311 for scheduling the PUSCH 317 of the UL CC2 307 is received, the UE transmits the PUSCH 317 in an (n+1)^{th} subframe on the UL CC2 307.

In order to reduce unnecessary power consumption of the UE, the LTE-A system can activate or deactivate each CC. When there is no data to be transmitted in DL or UL, the eNB controls the UE to deactivate the corresponding CC, resulting in a reduction of unnecessary power consumption.

Accordingly, there is a need for a method to immediately activate a deactivated CC, when there is data to be transmitted on the corresponding CC, so as to reduce transmission delay, thereby improving system efficiency.

### SUMMARY OF THE INVENTION

In order to solve at least the above-described problems of the prior art and to provide a number of advantages as described below, an aspect of the present invention is to provide a method and apparatus for activating a deactivated CC of a UE in a wireless communication system supporting carrier aggregation.

In accordance with an aspect of the present invention, a CC activation method is provided for a terminal in a mobile communication system supporting carrier aggregation for broadband service. The method includes receiving, from a BS, UL scheduling information for an UL CC in a deactivated state; determining whether a DL CC associated with the UL CC is activated; and activating, when the DL CC is deactivated, the DL CC.

In accordance with another aspect of the present invention, a control signal transmission method is provided for a BS for activating a CC for a terminal in a mobile communication system supporting carrier aggregation for broadband service. The method includes transmitting UL scheduling information for an UL CC in a deactivated state to the terminal; determining whether data is received from the terminal on the UL CC according to the scheduling information; and recognizing, when the data is received, that the terminal has activated the UL CC associated with the UL CC.

In accordance with another aspect of the present invention, a terminal is provided for activating a CC in a mobile communication system supporting carrier aggregation for broadband service. The terminal includes a Radio Frequency (RF) receiver that receives UL scheduling information for an UL CC in a deactivated state from a BS; and a carrier aggregation controller that determines, based on the scheduling information, whether a DL CC associated with the UL CC is activated, and activates, when the DL CC is deactivated, the DL CC.

In accordance with another aspect of the present invention, a BS is provided for transmitting a control signal for activating a CC for a terminal in a mobile communication system supporting carrier aggregation for broadband service. The BS includes a carrier aggregation controller that determines whether to aggregate UL CCs or DL CCs; and a scheduler that generates UL scheduling information on an UL CC in a deactivated state, transmits the UL scheduling information to the terminal, determines whether data is received from the terminal on the UL CC as indicated in the scheduling information, recognizes, when the data is received, that the UE has activated a DL CC associated with the UL CC, and retransmits the UL scheduling information to the terminal, when data is not received.

### BRIEF DESCRIPTION OF THE DRAWINGS

The above and other aspects, features, and advantages of certain embodiments of the present invention will be more apparent from the following detailed description in conjunction with the accompanying drawings, in which:

FIG. 1 is a block diagram illustrating conventional carrier aggregation of UL and DL CCs for an LTE-A system;

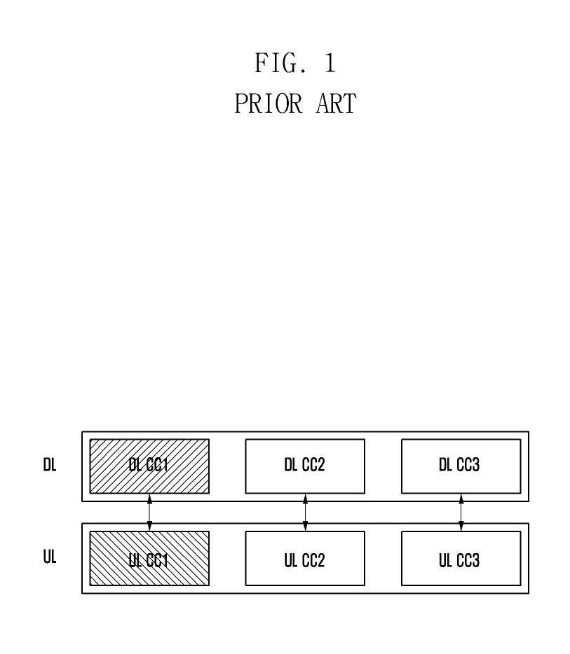

FIG. 2 is a diagram illustrating conventional UL data transmission scheduling in an LTE-A system supporting aggregation of two CCs in both UL and DL;

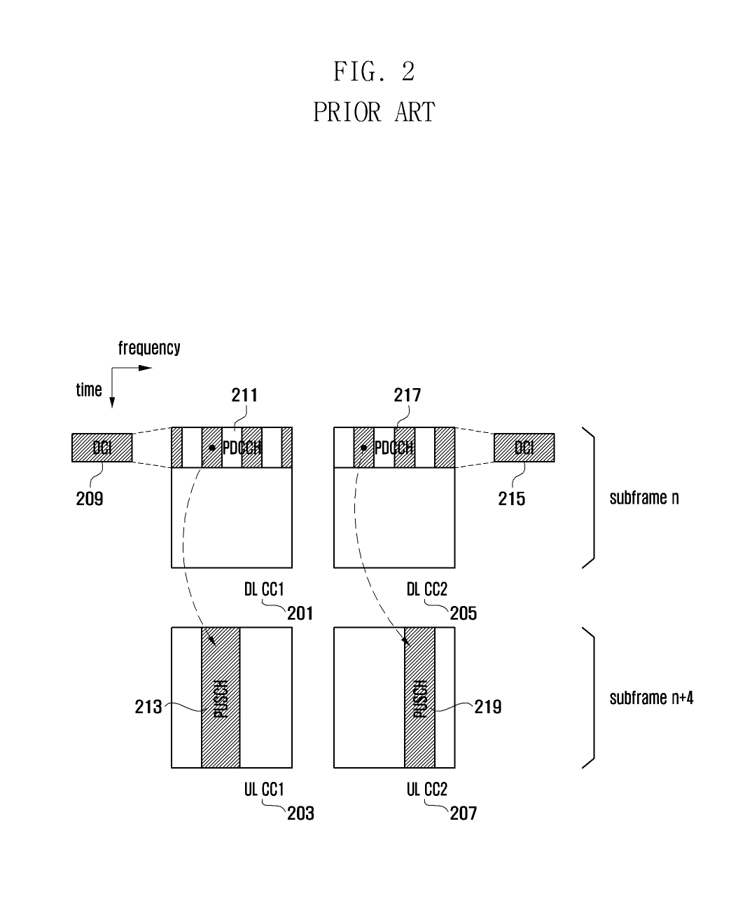

FIG. 3 is a diagram illustrating conventional UL data transmission scheduling in an LTE-A system supporting aggregation of two CCs in both UL and DL;

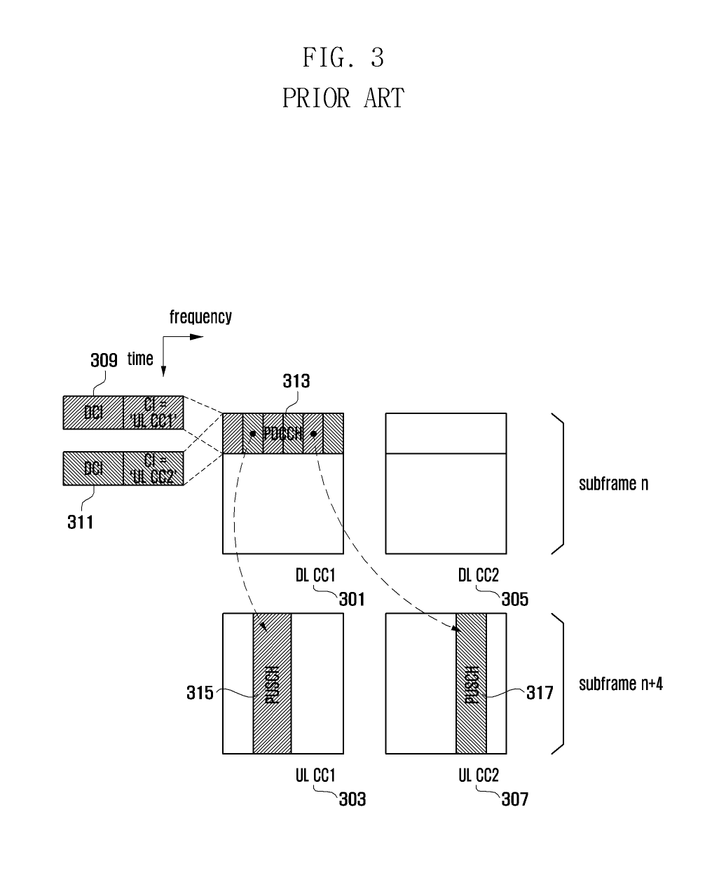

FIG. 4 is a diagram illustrating DL CC activation according to an embodiment of the present invention;

FIG. 5 is a flowchart illustrating a CC management procedure of a UE according to an embodiment of the present invention;

FIG. 6 is a flowchart illustrating a CC management procedure of an eNB an embodiment of the present invention;

FIG. 7 is a flowchart illustrating a modified CC management procedure of a UE according to an embodiment of the present invention;

FIG. 8 is a flowchart illustrating a CC management procedure of a UE according to an embodiment of the present invention;

FIG. 9 is a diagram illustrating DL CC activation according to an embodiment of the present invention;

FIG. 10 is a flowchart illustrating a CC management procedure of a UE according to an embodiment of the present invention;

FIG. 11 is a flowchart illustrating a CC management procedure of an eNB according to an embodiment of the present invention;

FIG. 12 is a diagram illustrating DL CC activation according to an embodiment of the present invention;

FIG. 13 is a flowchart illustrating a CC management procedure of an eNB according to an embodiment of the present invention;

FIG. 14 is a block diagram illustrating a BS apparatus according to an embodiment of the present invention; and

FIG. 15 is a block diagram illustrating a UE according to an embodiment of the present invention.

### DETAILED DESCRIPTION OF EMBODIMENTS OF THE INVENTION

Various embodiments of the present invention are described in detail below with reference to the accompanying drawings. The same reference numbers are used throughout the drawings to refer to the same or like parts. Detailed descriptions of well-known functions and structures incorporated herein may be omitted to avoid obscuring the subject matter of the present invention. Also, the terms used in the following description are defined taking into consideration the functions provided in the present invention. The definitions of these terms should be determined based on the whole content of this specification, because they may be changed in accordance with the option of a user or operator or a usual practice.

Although embodiments of the present invention will be described below in relation to Advanced Evolved Universal Mobile Telecommunications Service (UMTS) Terrestrial Radio Access (E-UTRA) (or LTE-A) supporting carrier aggregation, the embodiments of the present invention can also be modified for other communication systems having the similar technical background and channel types, without departing from the subject matter of the present invention. For example, carrier aggregation can also be applied to the multicarrier High Speed Packet Access (HSPA) without departing from the subject matter of the present invention.

In accordance with an embodiment of the present invention, a method and apparatus are provided for immediately activating deactivated CCs of a UE without additional signaling overhead in a wireless communication system supporting high data rate transmission with carrier aggregation. Specifically, if an UL scheduling grant is received for scheduling transmission on a deactivated UL CC, the UE activates the deactivated UL CC along with a previously associated DL CC, measures the received signal strength of the DL CC, and reports the received signal strength measured. The DL CC to be associated with the UL CC is configured per UE by an eNB. When the UL CC scheduling command is received for an UL CC that is already activated, the UE initializes (or restarts) a deactivation timer so as to extend an activation time of the DL CC. The deactivation timer is used to prevent a CC from staying in an activated state too long, especially when the UE has missed a deactivation command for the DL CC or there is no transmit data for predetermined time duration. Basically, the deactivation timer is used to transition the corresponding DL CC to the deactivated state, when the deactivation timer expires.

Through the aforementioned operations, the UE can more accurately calculate an initial transmit power of a data channel on a UL CC, or an eNB supports quick and accurate scheduling operation on the DL CC. Also, it is expected to distribute the DL control channels across the DL CCs.

The aforementioned method according to an embodiment of the present invention can be applied without restriction on the number of CCs for wide bandwidth through carrier aggregation.

In accordance with an embodiment of the present invention, a DL or UL CC can be in an activated state or deactivated state. If a DL CC is in an activated state, this UE monitors the DL CC for PDCCH and continuously performs measurement. If a DL CC is in a deactivated state, the UE does not monitor the corresponding DL CC for PDCCH and the measurement on the DL CC is performed at low frequency or not at all. The measurement includes a path loss measurement on a corresponding DL CC and CQI measurement for link adaptation such as MCS of data to be transmitted on the corresponding DL CC. The more frequent the measurement is performed, the higher the path loss calculation accuracy and link adaptation accuracy of the DL data become.

If the UL scheduling information (UL grant) for an UL CC is received, the UE starts UL data transmission.

In accordance with the embodiments of the present invention described herein, when UL scheduling information for an UL CC is received and a DL CC associated with the UL CC is in a deactivated state, a UE can deactivate a corresponding DL CC.

In accordance with an embodiment of the present invention, in an LTE-A system supporting carrier aggregation in which, when UL scheduling information for an UL CC is received and a DL CC associated with the UL CC is in a deactivated state, a UE activates the DL CC without additional signaling.

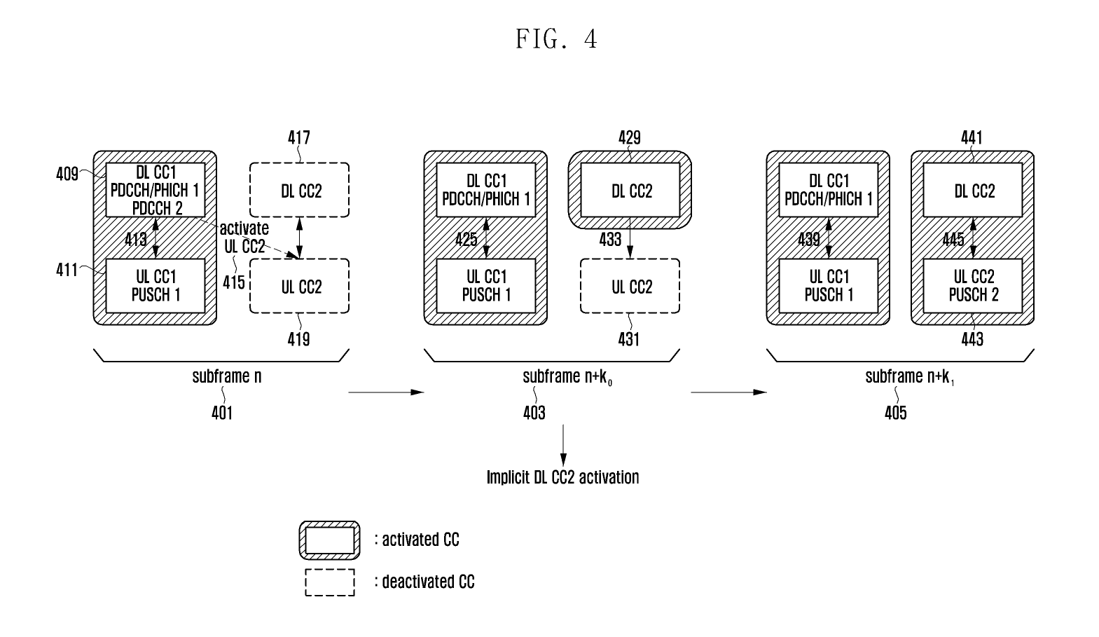

FIG. 4 is a diagram illustrating DL CC activation according to an embodiment of the present invention.

Referring to FIG. 4, two DL CCs DL CC1 and DL CC2 and two UL CCs UL CC1 and UL CC2 are configured. It is assumed that the DL CC1 and UL CC1 are associated with each other and the DL CC2 and UL CC2 are associated with each other. If a DL CC is associated with an UL CC, the UL scheduling information for scheduling the data to be transmitted on the UL CC is transmitted on the DL CC associated with the UL CC.

In a system in which a UE references path loss of a DL CC to determine a transmit power of data or a control signal to be transmitted on an UL CC in order, the DL CC of which path loss is referenced is associated with the UL CC, are in path loss relationship. If an UL CC is in a path loss relationship with a DL CC, the path loss of the DL CC is referenced for determining an UL transmit power of the UL CC.

How many and which UL and DL CCs are aggregated and the association between the UL and DL CCs are configured at the UE by higher layer signaling in a call establishment process.

In FIG. 4, the DL CC1 409 and UL CC1 411 are activated in an n^{th} subframe and the DL CC2 417 and UL CC2 419 are deactivated. Accordingly, there is data and control signal transmission 413 between the DL CC1 409 and UL CC1 4011 while there is no data and control signal transmission between the DL CC2 417 and UL CC2 419. The UL data is transmitted ion a PUSCH, the UL scheduling information for the PUSCH scheduling is transmitted on a PDCCH, and HARQ-ACK corresponding to the PUSCH is transmitted on a Physical HARQ Indicator Channel (PHICH).

An eNB sends a UE UL scheduling information asking the UE to transmit the UL data on the UL CC2 417 in the n^{th} subframe 401, as denoted by reference number 415. The UL scheduling information about the UL CC2 417 is transmitted in the PDCCH2 on the DL CC1 409, which is currently activated. In this embodiment, the PDCCH carrying the UL scheduling information for the UL CC2 419 is called PDCCH2 for simplicity. The UL scheduling information for the UL CC2 419 is supposed to be transmitted on the DL CC2 417 associated with the UL CC2 419, according to a previous configuration, but because the DL CC2 417 is in a deactivated state, is transmitted on the DL CC1 409, which is already activated. That is, when the DL CC associated with the target UL CC is in a deactivated state, the UL scheduling information for the UL CC is transmitted on another DL CC that is separately preconfigured. When the DL CC associated with the target UL CC is in an activated state, the scheduling information is transmitted on the associated DL CC.

In an (n+k₀)^{th} subframe, the UE detects the arrival of the scheduling information for the UL CC2 419 by decoding the PDCCH2, which is transmitted in the n^{th} subframe 401 by the eNB. Upon receipt of the scheduling information, the UE prepares activation of the UL CC2 419 and transmission of a PUSCH in an (n+k₁)^{th} subframe 405. The parameter k₀ is determined based on a time for decoding the PDCCH2 of the UE and typically set to a value less than 1 subframe in size.

After scheduling information for the UL CC2 419 is acquired, the UE activates the DL CC2 417 associated with the UL CC2 419 without separate signaling. The UE measures the DL path loss and CQI of the activated DL CC2 428 in the (n+k₀)^{th} subframe 403 as denoted by reference number 433.

The UE activates the UL CC2 443 in the (n+k₁)th subframe and transmits UL data in the PUSCH2 on the UL CC2 443 according to the scheduling information for the UL CC2 443, which is acquired in the subframe (n+k0)^{th} subframe. The parameter k₁ is determined in consideration of the PDCCH2, the single processing time for the PDCCH2, and a HARQ time, and is set to a fixed value of 4 subframes in legacy LTE and LTE-A systems. The k₀ is set to a value less than k₁.

Upon receipt of the PUSCH2 from the UE, the eNB recognizes that the UE activates the DL CC2 by itself.

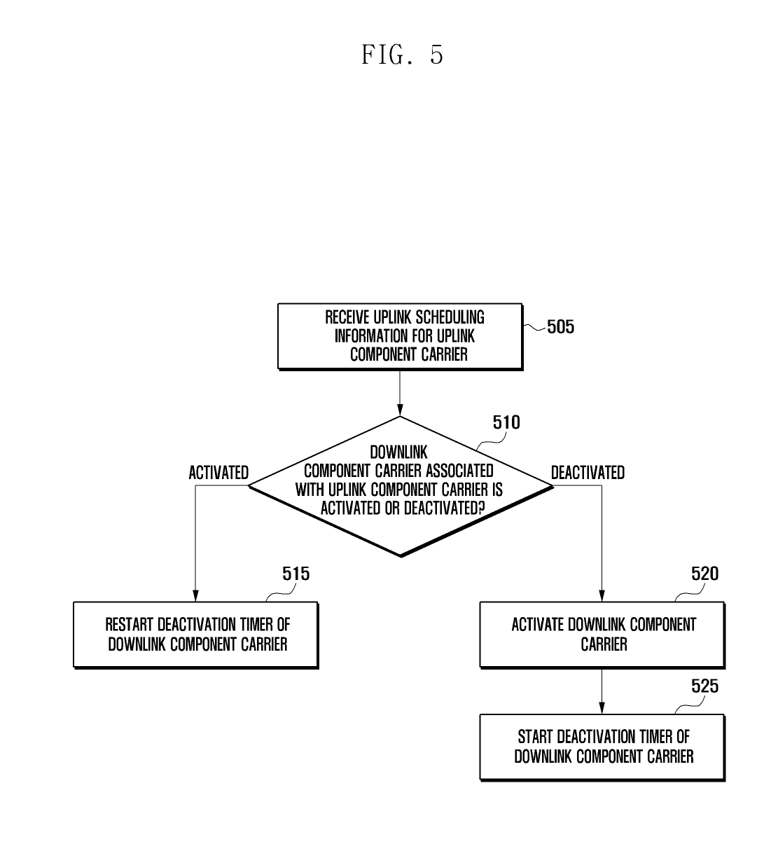

FIG. 5 is a flowchart illustrating a CC management procedure of a UE according to an embodiment of the present invention.

Referring to FIG. 5, the UE receives UL scheduling information for an UL CC in step 505, and checks a state of a DL CC associated with the UL CC in step 510.

If it is determined that the DL CC is in an activated state at step 510, the DL CC is in the activated state already and the deactivation timer for the DL CC is running. Therefore, the UE restarts the deactivation timer for the DL CC in step 515.

However, if it is determined that the DL CC is in a deactivated state at step 510, the UE activates the DL CC associated with the UL CC in step 520 and then starts the deactivation timer of the DL CC in step 525.

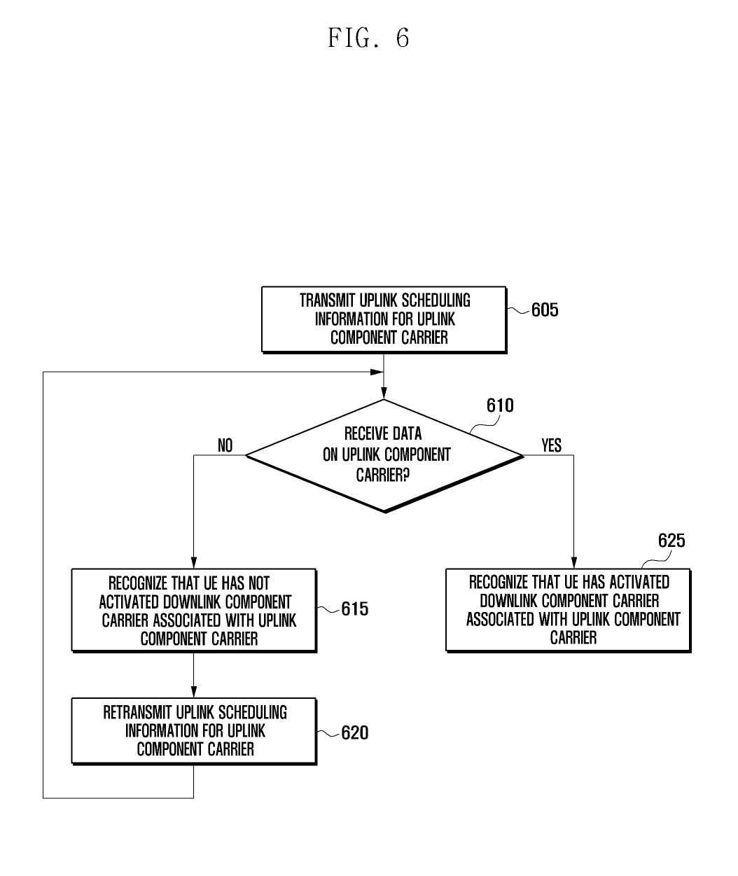

FIG. 6 is a flowchart illustrating a CC management procedure of an eNB according to an embodiment of the present invention.

Referring to FIG. 6, the eNB sends the UL scheduling information for a specific UL CC according to a scheduling result of the UE in step 605. In step 610, the eNB checks whether data is received on the UL CC that is transmitted, according to the scheduling information.

If no data is received on the UL CC, eNB recognizes that the UE has not activated the DL CC associated with the UL CC in step 615, and the eNB retransmits the UL scheduling information for the UL CC in step 620. Thereafter, the eNB repeats step 610.

If there is data received on the UL CC in step 610, the eNB recognizes that the UE has activated the DL CC associated with the UL CC in step 625.

Alternatively, a UE operation can start at a reference time point when UL data transmission begins according to UL scheduling information, rather than at a reference time point when UL scheduling information is received. That is, the above-described procedure of the UE can be modified such that the UE transmits UL data on an UL CC at step 505.

In accordance with another embodiment of the present invention, a DL CC associated with a UL component subcarrier for UL transmission can be configured to be activated only when an amount of UL transmission data is equal to or greater than a predetermined threshold, rather than being activated when any data is present. That is, an additional step may be added between steps 505 and 510 of the UE procedure illustrated in FIG. 5, wherein the UE compares the amount of the transmission-available data with the threshold value notified previously, and performs step 510, when the amount of the transmission-available data is greater than the predetermined threshold value.

In accordance with another embodiment of the present invention, a DL CC associated with an UL CC may be automatically activated when a UL CC is activated.

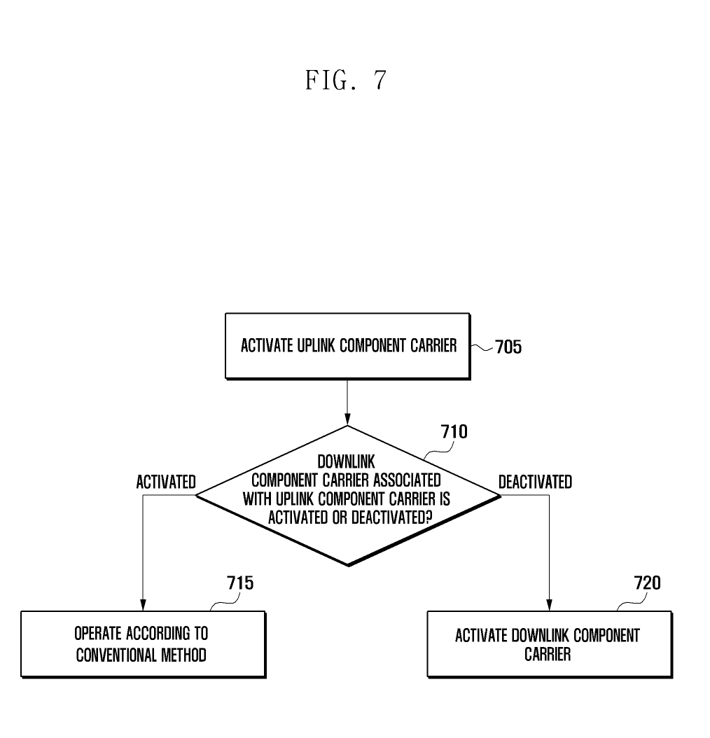

FIG. 7 is a flowchart illustrating a modified CC management procedure of a UE according to an embodiment of the present invention.

Referring to FIG. 7, a UL CC is activated in step 705. For example, the UL CC can configured to be activated when the UL scheduling information for the UL CC is received. In step 710, the UE checks the state of the DL CC associated with the UL CC. If the UL CC is in an activated stated, the UE performs a necessary operation according to the conventional method. However, if the UL CC is in a deactivated state, the UE activates the DL CC associated with the corresponding UL CC in step 720.

In accordance with an embodiment of the present invention, in an LTE-A system supporting carrier aggregation in which, when UL scheduling information for a UL CC is received and a DL CC associated with the UL CC is in a deactivated state, a UE activates a corresponding DL CC without additional signaling and configures transmit power for the UL data transmission according to the UL scheduling information.

Referring again to FIG. 4, in the (n+k₀)^{th} subframe 403, the UE performs decoding on the PDCCH2 transmitted, in the nth subframe 401, by the eNB and is aware of the receipt of the scheduling information destined to UE itself for the UL CC2 431. In this case, the UE activates) the UL CC2 443 and prepares for PUSCH transmission in the (n+k₁)^{th} subframe 405. k₀ is determined according to the PDCCH decoding time and typically considered as a relatively small value around one subframe.

After scheduling information for the UL CC2 is acquired, the UE activates the DL CC2 429 associated with the UL CC2 without explicit signaling. Next, the UE measures the DL pass loss value for the activated DL CC2 429 by the (n+k₀)^{th} subframe 403 as denoted by reference number 433.

In the (n+k₁)^{th} subframe 405, the UE activates the UL CC2 443 and sends the UL data in the PUSCH2 on the UL CC2 443 according to the scheduling information for the UL CC2 431 acquired in the subframe (n+k₀)^{th} subframe 403, as denoted by reference number 445. k₁ is determined in consideration of the PDCCH2, PUSCH2 processing time, and HARQ timing of the UE and is typically set to a fixed value of 4 subframes in LTE and LTE-A systems. k₀ has relatively small value when compared to the k₁.

In the (n+k₁)^{th} subframe 405, the transmit power of the PUSCH2 transmitted by the UE is determined based on the DL path loss value for the DL CC2 429 measured, in (n+k₀)^{th} subframe 403, by the UE and the power control command included in the UL scheduling information acquired in the (n+k₀)^{th} subframe 403.

For example, the PUSCH transmission power in the i^{th} subframe on the k^{th} UL CC is determined according to Equation (1).

P_{PUSCH}(i,k)=min{P_{CMAX}, 10log₁₀(M_{PUSCH}(i,k))+P_{O}_{_{—}}_{PUSCH}(j,k)+α(j,k)*PL(k)+Δ_{TF}(i,k)+f(i,k)} (1)

In Equation (1), P_{CMAX} is a maximum transmit power available for the UE and determined by a class of UE and higher layer signaling, M_{PUSCH}(i,k) is a number of Physical RBs (PRBs) as the resource amount scheduled by the eNB for the i^{th} subframe of the k^{th} UL CC, P_{O}_{_{—}}_{PUSCH}(j,k) is an interference amount measured by the eNB for the k^{th} CC, and the index j is set to a value according to the type of data scheduled, i.e., j=1 for the semi-persistent data of which scheduling information is maintained for a predetermined time duration, j=2 for the data of dynamic scheduling, and j=3 for the UL data transmission in the random access process. Further, α(j,k) is a value for partially compensating for path loss between eNB and UE for the k^{th} CC (0≦α(j,k)≦1), and PL(k) is the path loss between eNB and UE for the k^{th} CC and calculated from the difference between the transmit power of the reference signal (RS) on the k^{th} CC, which is signaled by the eNB and the UE's received signal strength level on the RS. Additionally, Δ_{TF}(i,k) is a power offset according to a Transport Format (TF) or MCS of data scheduled by the eNB in the i^{th} subframe of the k^{th} UL CC, and f(i,k) is calculated from the power control command included in the UL scheduling information of the eNB for the i^{th} subframe of the k^{th} UL CC.

Through the above-described operations, the UE reflects the DL path loss value measured most recently for calculating the transmit power of the PUSCH2 in order to acquire more accurate transmit power. The DL path loss value can be calculated from the DL path loss value measured by the UE previously for the DL CC2 as well as the DL path loss value for the DL CC2 measured by the UE in (n+k₀)^{th} subframe and, in this case, the most recently measured path loss value is assigned relatively high weight.

If the PUSCH2 is received from the UE, the eNB is implicitly aware that the UE has activated the DL CC2.

Alternatively, the relative time relationship between k₀ and k₁ can be defined unlike that as described above. That is, it can be defined as the minimum integer satisfying k₁−k₀≧4 to secure the time enough for reflecting the UL transmission power calculation after the path loss measurement. For example, if k₀ is 1, k₁ becomes 5.

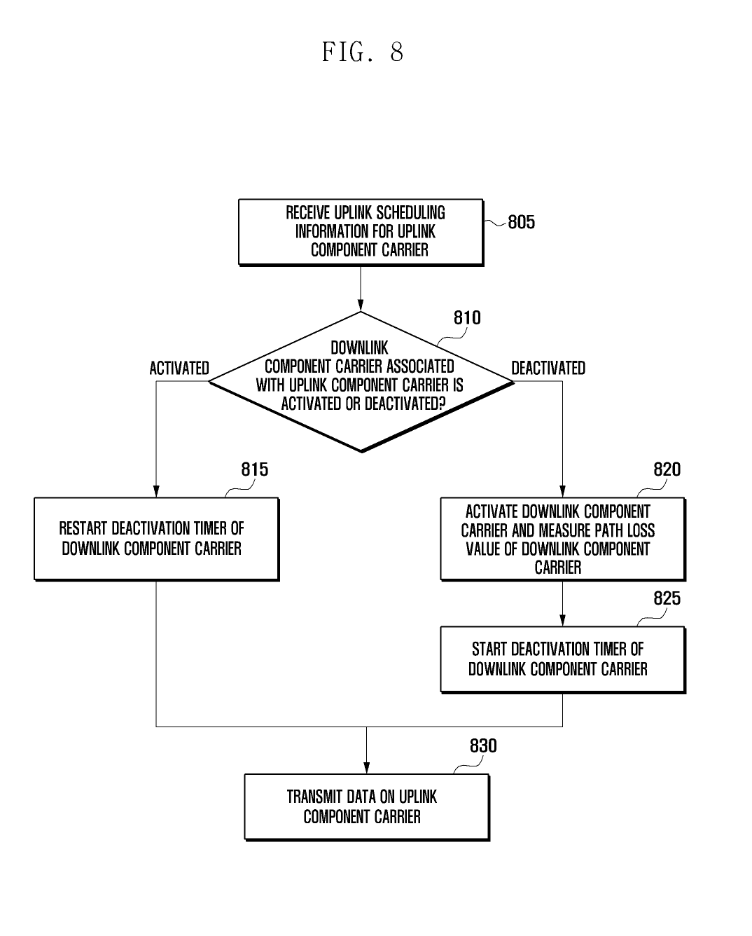

FIG. 8 is a flowchart illustrating a CC management procedure of a UE according to an embodiment of the present invention.

In FIG. 8, steps 805, 810, 815, 820, and 825 are the same as steps 505, 510, 515, 520, and 525 of FIG. 5, except that in step 820, in additional to the UE activating the DL CC associated with the corresponding UL CC, and the UE also measures the path loss value of the DL CC. Accordingly, a repetitive description of these steps of FIG. 8 will not be provided.

After restarting the deactivation timer in step 815 or starting the deactivation timer of the DL CC in step 825, the UE transmits data on the UL CC (830) according to the UL scheduling information received at step 805.

In accordance with an embodiment of the present invention, in an LTE-A system supporting carrier aggregation in which, in order to activate a DL CC, a UE transmits UL scheduling formation for scheduling on a UL associated with the DL CC and activates, when the UL scheduling information is received, the DL CC associated with the UL CC without additional signaling. The UL scheduling information includes a command instructing the UE to measure and report CQI for the DL CC associated with the UL CC, such that the UE feeds back the CQI to the eNB. Accordingly, the eNB can quickly and precisely determine the MCS level for DL data transmission on the DL CC.

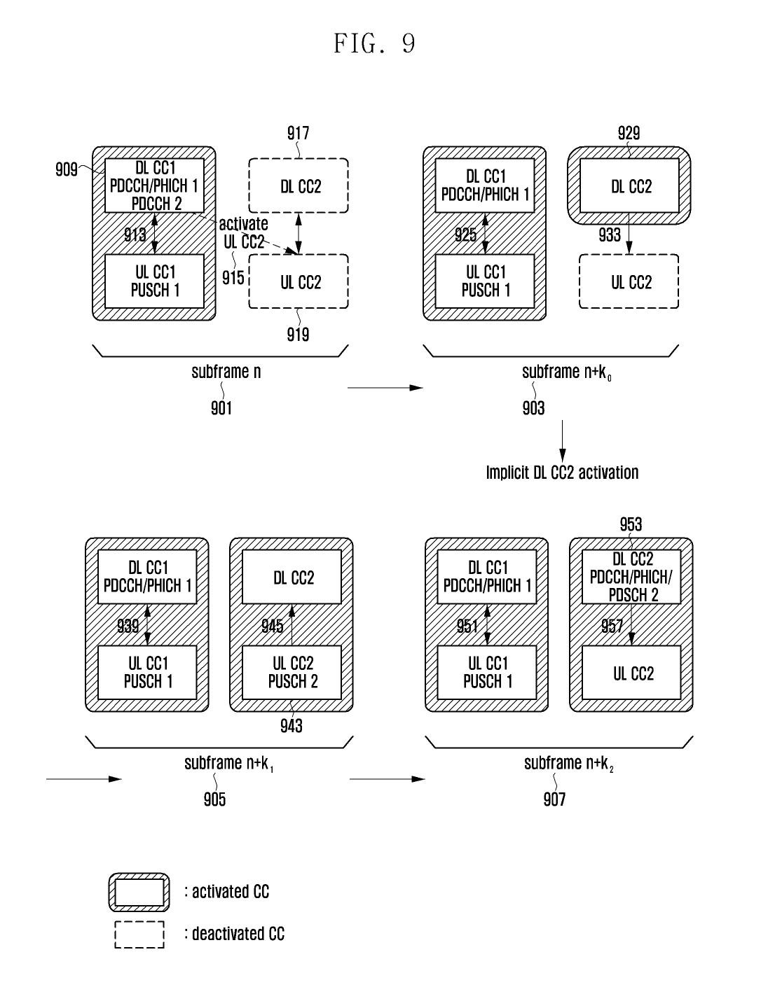

FIG. 9 is a diagram illustrating DL CC activation according to an embodiment of the present invention. The assumptions and basic operations in FIG. 9 follow the description of FIG. 4, and thus, detailed descriptions of operations identical with those of already described for FIG. 4 are omitted herein.

Referring to FIG. 9, in an n^{th} subframe 901, an eNB sends a UE UL scheduling information for UL data transmission on a UL CC2 919 as denoted by reference number 915. The UL scheduling information for the UL CC2 919 is carried in the PDCCH2 on the DL CC1 909. The PDCCH carrying the UL scheduling information on the UL CC2 is called PDCCH2 for simplicity. The UL scheduling information includes a command instructing the UE to measure and report the CQI of the DL CC2 917 associated with the UL CC2 919.

In an (n+k₀)^{th} subframe 903, the UE performs decoding on the PDCCH2 transmitted by the eNB in the n^{th} subframe 901 and is aware of the arrival of the scheduling information on the UL CC2 919, which is destined to UE itself. In this case, the UE activates the UL CC2 943 and prepares for PUSCH transmission in an (n+k₁)^{th} subframe 905.

k₀ is determined according to the PDCCH2 decoding time and is typically considered as a relatively small value around one subframe.

After scheduling information for the UL CC2 919 is acquired, the UE activates the DL CC2 917 associated with the UL CC2 919 without explicit signaling. Next, the UE measures the DL pass loss value and CQI for the activated DL CC2 929 by (n+k₀)^{th} subframe 903 as denoted by reference number 933.

In (n+k₁)^{th} subframe 905, the UE activates the UL CC2 943 and sends the UL data in the PUSCH2 on the UL CC2 943 according to the scheduling information for the UL CC2 943 acquired in the subframe (n+k₀)^{th} subframe 903, as denoted by reference number 945.

According to the CQI report command included in the UL scheduling information acquired in the (n+k₀)^{th} subframe 903, the UE transmits the measured CQI in the (n+k₀)^{th} subframe 903 along with data on the PUSCH2. The CQI can be calculated from the measurement values acquired from several previous subframes, and in this case, the most recently received CQI is assigned weight.

k₁ is determined in consideration of the PDCCH2, PUSCH2 processing time, and HARQ timing of the UE and is typically set to a fixed value of 4 subframes in LTE and LTE-A systems. k₀ has relatively small value when compared to the k₁.

In the (n+k₁)^{th} subframe 905, the transmit power of the PUSCH2 transmitted by the UE is determined based on the DL path loss value for the DL CC2 929 measured, in (n+k₀)^{th} subframe 903, by the UE and the power control command included in the UL scheduling information acquired in the (n+k₀)^{th} subframe 903.

Upon receipt of the PUSCH2 from the UE, the eNB is implicitly aware that the UE has activated the DL CC2 929.

In an (n+k₂)^{th} subframe 907, the eNB determines the MCS for transmitting data on the DL CC2 953 by referencing the CQI measurement value reported by the UE and transmits the data on the PDSCH2 as denoted by reference number 957.

The eNB transmits the control information such as MCS and transport format determined for the PDSCH2 on the PDCCH along with the PDSCH2. The eNB also transmits HARQ-ACK for the PUSCH2, which is received from the UE, to the UE on PHICH2. k₂ is determined in consideration of the PUSCH2, PDSCH2 processing time, and HARQ time of the eNB and is typically set to a fixed value of 8 subframes in LTE and LTE-A systems.

Alternatively, the relative time relationship among k₀, k₁, and k₂ can be defined as a minimum integer satisfying k₁−k₀≧4 to secure the time enough for the UE to perform UL transmission after the CQI measurement and additional condition of k₂−k₁=4. For example, if k₀ is 1, k₁ becomes 5 and k₂ becomes 9.

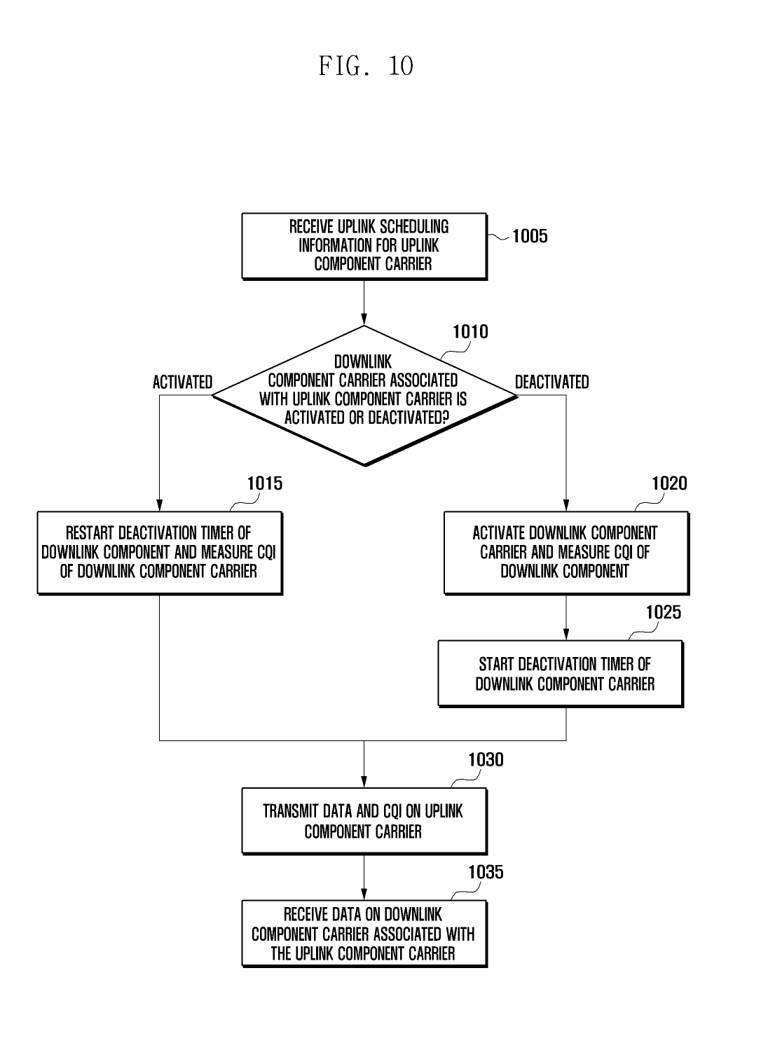

FIG. 10 is a flowchart illustrating a CC management procedure of a UE according to an embodiment of the present invention.

In FIG. 10, steps 1005, 1010, 1015, 1020, and 1025 are the same as steps 505, 510, 515, 520, and 525 of FIG. 5, except that in steps 1015 and 1020 in addition to restarting the deactivation timer for the DL CC in step 1015 and activating the DL CC associated with the corresponding UL CC in step 1020, the UE also measures CQI of the DL CC according to the CQI report command contained in the UL scheduling information received at step 1005. Accordingly, a repetitive description of these steps of FIG. 10 will not be provided.

After restarting the deactivation timer in step 1015 or starting the deactivation timer of the DL CC in step 1025, the UE multiplexes the data and CQI on the UL CC according to the UL scheduling information received at step 1005 and transmits the multiplexed data and CQI in step 1030. In step 1035, the UE receives data on the DL CC associated with the UL CC.

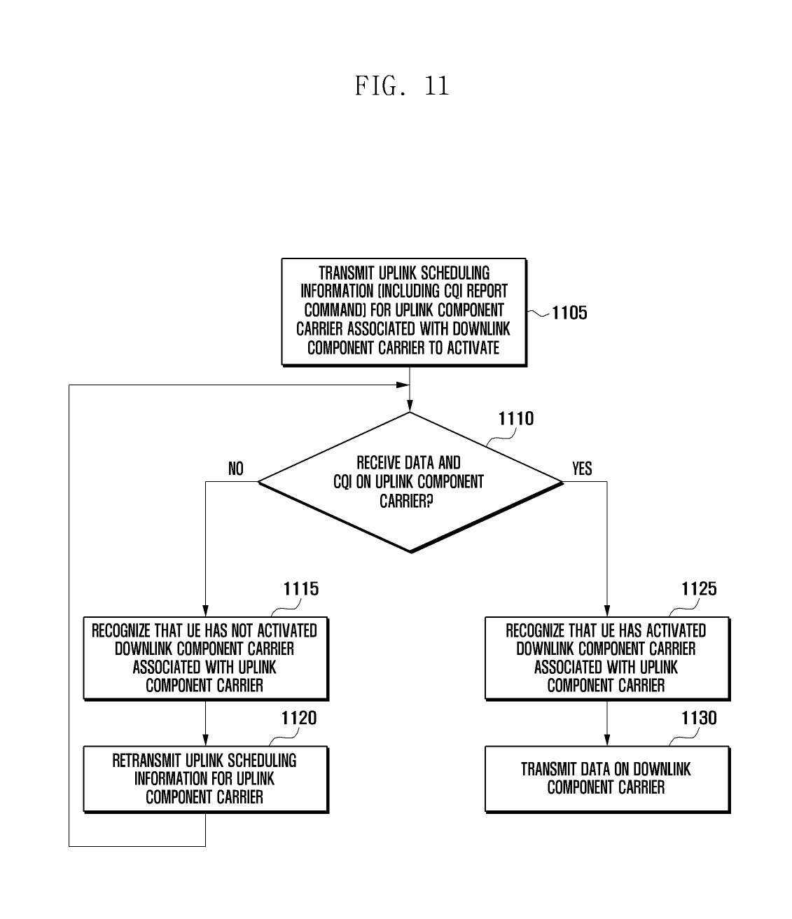

FIG. 11 is a flowchart illustrating a CC management procedure of an eNB according to an embodiment of the present invention.

Referring to FIG. 11, the eNB sends a UE UL scheduling information for a UL CC associated with a DL CC intended to be activated, along with a CQI report command, in step 1105. In step 1110, the eNB determines whether data and CQI are received from the UE on the UL CC according to the scheduling information transmitted at step 1105.

If the data and CQI are not received on the UL CC, the eNB recognizes that the UE has not activated the DL CC associated with the UL CC in step 1115, and retransmits the UL scheduling information including a CQI report command for the UL CC to the UE in step 1120. Afterward, the procedure returns to repeat step 1110.

If the data and CQI are received on the UL CC in step 1110, the eNB recognizes that the UE has activated the DL CC associated with the UL CC in step 1125, and transmits MCS and a transport format for the data to be transmitted on the DL CC, which are determined with reference to the CQI acquired from the UE, in step 1130.

In accordance with an embodiment of the present invention, in an LTE-A system supporting carrier aggregation in which, when UL scheduling information for a UL CC is received and a DL CC associated with the UL CC is in an deactivated state, the UE activates the corresponding DL CC without additional signaling, and the eNB transmits the DL control channel for the UL CC on the DL CC associated with the UL CC.

The UL scheduling information includes a command instructing the UE to measure and report CQI for the DL CC associated with the UL CC, and the UE reports the CQI to the eNB according to the command. When the DL control channel corresponding to the UL CC is sent on the DL CC, the eNB transmits the DL control channel in a format relatively appropriate for the DL channel status in order to prevent the control channel transmission from being concentrated on a specific DL CC, thereby reducing control signal overhead.

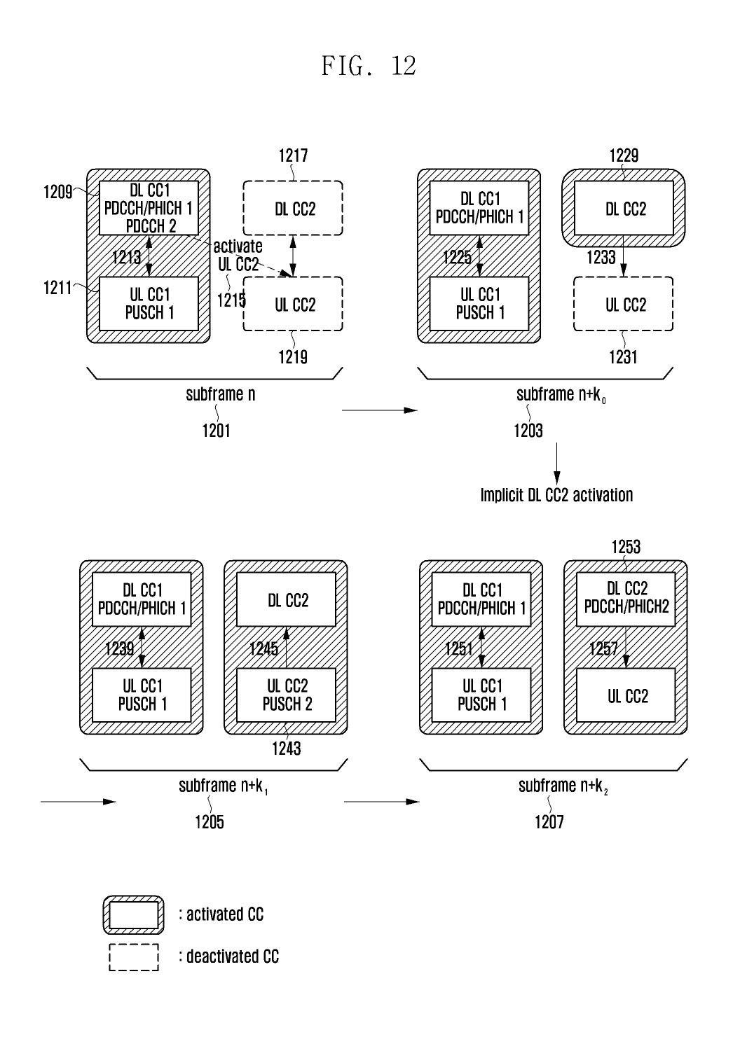

FIG. 12 is a diagram illustrating DL CC activation according to an embodiment of the present invention. The assumptions and basic operations in FIG. 12 follow the description of FIG. 9, and thus, detailed description of the operations identical with those of FIG. 9 are omitted herein.

Referring to FIG. 12, in an n^{th} subframe 1201, an eNB sends a UE UL scheduling information for UL data transmission on a UL CC2 1219 as denoted by reference number 1215. The UL scheduling information for the UL CC2 is carried in the PDCCH2 on the DL CC1, which is currently activated. The UL scheduling information includes a command instructing the UE to measure and report the CQI of the DL CC2 1217 associated with the UL CC2 1219. The eNB also can transmit, on the DL CC1 1209, the control information such as PDCCH1 for scheduling the UL data on the UL CC1 1211 associated with the DL CC1 1209 and PHICH1 for transmitting HARQ-ACK corresponding to the UL data transmission of the UL CC1 1209. Accordingly, the DL control channel transmission is likely to be concentrated on the DL CC in one or more subframes in order to reduce resources for DL transmission or marginal transmit power of the eNB.

In an (n+k₀)^{th} subframe 1203, the UE performs decoding on the PDCCH2 transmitted by the eNB in n^{th} subframe 1201 and is aware of the receipt of the scheduling information on the UL CC2 1219, which is destined to UE itself. In this case, the UE activates the UL CC2 1231 and prepares for PUSCH transmission in (n+k₁)^{th} subframe 1205. k₀ is determined according to the PDCCH2 decoding time and is typically considered as a relatively small value around one subframe.

After scheduling information for the UL CC2 1219 is acquired, the UE activates the DL CC2 1229 associated with the UL CC2 1231 without explicit signaling. Next, the UE measures the DL pass loss value and CQI for the activated DL CC2 1229 by (n+k₀)^{th} subframe 1203, as denoted by reference number 1233.

In an (n+k₁)^{th} subframe 1205, the UE activates the UL CC2 1243 and sends the UL data in the PUSCH2 on the UL CC2 1243 according to the scheduling information for the UL CC2 1231 acquired in the subframe (n+k₀)^{th} subframe 1203, as denoted by reference number 1245. The UE multiplexes the CQI, which is measured in the (n+k₀)^{th} subframe 1203, with the data on the PUSCH2 and transmits the multiplexed CQI and data to the eNB according to the CQI report command contained in the UL scheduling information. The CQI can be calculated from the measurement values acquired across several previous subframes, and in this case, the most recently received CQI is assigned weight.

k₁ is determined in consideration of the PDCCH2, PUSCH2 processing time, and HARQ timing of the UE and typically set to a fixed value of 4 subframes in LTE and LTE-A systems. k₀ has relatively small value when compared to the k₁.

In the (n+k₁)^{th} subframe 1205, the transmit power of the PUSCH2 transmitted by the UE is determined based on the DL path loss value for the DL CC2 1229 measured, in (n+k₀)^{th} subframe 1203, by the UE and the power control command included in the UL scheduling information acquired in the (n+k₀)^{th} subframe 1203.

Upon receipt of the PUSCH2 from the UE, the eNB is implicitly aware that the UE has activated the DL CC2 1229.

In (n+k₂)^{th} subframe 1207, the eNB determines the DL control channel to be transmitted on the DL CC2 1253 and adjusts the transmit power or coding rate of the control channel to be transmitted according to the DL channel status. The DL control channel can be PDCCH2 for scheduling PUSCH2 or PHICH2 for transmitting HARQ-ACK corresponding to the PUSCH2.

Although the scheduling information for the UL CC2 is carried by the PDCCH2 in the n^{th} subframe on the DL CC1 1209, it can be transmitted on the DL CC2 1253 according to the status in (n+k₂)^{th} subframe 1207, e.g., when the available resource is lack on the DL CC1 or the DL channel status of the DL CC2 is not good enough.

k₂ is determined in consideration of the PDSCH2 processing time and HARQ time of the eNB and is typically set to a fixed value of 8 subframes in LTE and LTE-A systems.

Alternatively, the DL control channel corresponding to the UL CC2 can be defined such that, when the UL CC2 is activated, data is always transmitted on the DL CC2 associated with the UL CC2 according to a previous configuration.

In accordance with another embodiment of the present invention, a relative time relationship among k₀, k₁, and k₂ can be defined as a minimum integer satisfying k₁−k₀≧4 to secure the time enough for the UE to perform UL transmission after the CQI measurement and additional condition of k₂−k₁=4. For example, if k₀ is 1, k₁ becomes 5, and k₂ becomes 9.

A UE operates according to FIG. 12, as described in FIG. 10, except that in step 1035, however, the UE can receive the control channel on the DL CC associated with the UL CC or on the DL CC on which the PDCCH with which the UL CC is scheduled.

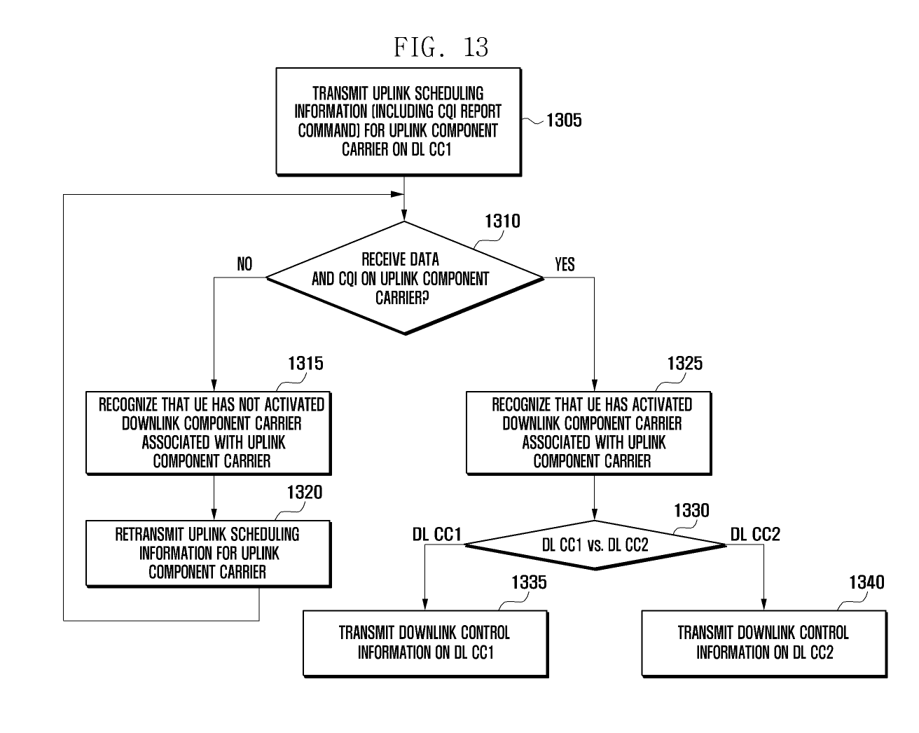

FIG. 13 is a flowchart illustrating a CC management procedure of an eNB according to an embodiment of the present invention.

Referring to FIG. 13, the eNB sends a UE UL scheduling information for a UL CC on a DL CC1 along with a CQI report command in step 1305. In step 1310, the eNB determines whether data and CQI are received from the UE on the UL CC according to the scheduling information transmitted at step 1305.

If the data and CQI are not received on the UL CC, the eNB recognizes that the UE has not activated the DL CC associated with the UL CC in step 1315, and retransmits the UL scheduling information including a CQI report command for the UL CC to the UE in step 1320. Afterward, the procedure returns to repeat step 1310.

If the data and CQI are received on the UL CC at step 1310, the eNB recognizes that the UE has activated the DL CC associated with the UL CC in step 1325, and compares the channel statuses and available resource amounts of the DL CC1 and DL CC2 with each other to determines whether to transmit the DL control information such as PDCCH or PHICH on the DL CC1 or DL CC2 in step 1330.

If the eNB determines to transmit the DL control information on the DL CC1 in step 1330, the eNB transmits the DL control information containing the transmit power and coding rate of the DL control channel that are adjusted to be appropriate for the DL channel status of the DL CC1 in step 1335. However, if is the eNB determines to transmit the DL control information on the DL CC2 in step 1330, the eNB transmits the DL control information containing the transmit power and coding rate of the DL control channel that are adjusted to be appropriate for the DL channel status of the DL CC2 in step 1340.

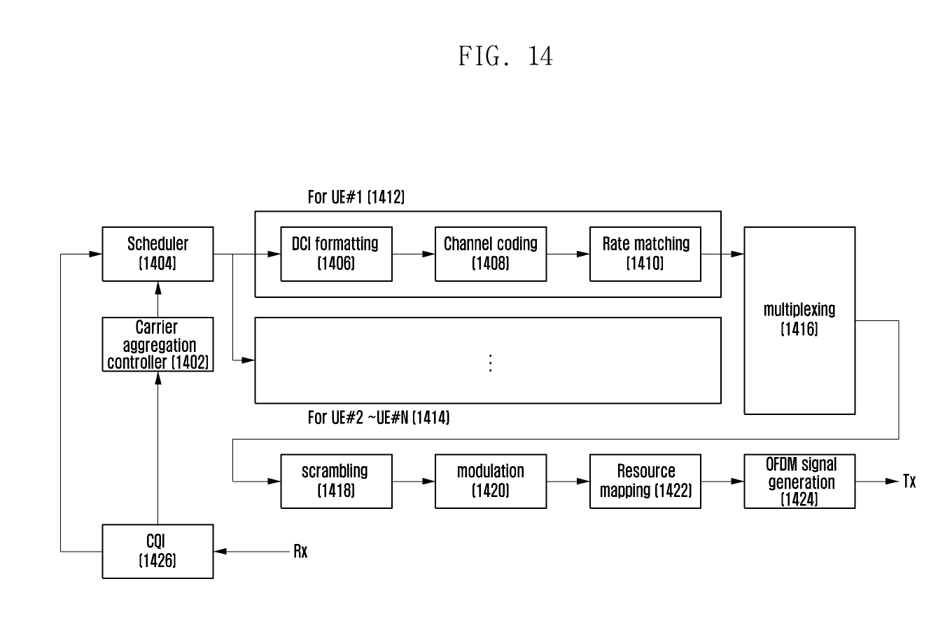

FIG. 14 is a block diagram illustrating a BS apparatus according to an embodiment of the present invention.

Referring to FIG. 14, the BS includes a carrier aggregation controller 1402 that determines whether to aggregate DL or UL carriers according to a data amount to be transmitted to a UE, resource amounts available within the system, whether there is a scheduling request from the UE, and CQI, and notifies a scheduler 1404 of the determination result. The CQI acquired from the UE is used for the carrier aggregation controller 1402 to determine whether to aggregate carriers and the scheduler 1404 to perform scheduling.

More specifically, if UE#1 is to activate a deactivated UL CC, the scheduler 1404 generates DL control information including UL scheduling information for the UL CC. For this purpose, the scheduler 1404 controls a DCI formatter 1406 to generate a DCI with the scheduling information for the UL CC along with the carrier indicator indicating the UL CC. After a Cyclic Redundancy Check (CRC) is added in the channel coder 1408, the DCI is rate matched by the rate matcher 1410, and then multiplexed with DCIs of other UEs by a multiplexer 1416. The multiplexed signal is scrambled by a scrambler 1418, modulated by a modulator 1420, and then mapped to a time-frequency resource by a resource mapper 1422. Thereafter, the resource-mapped signal is modulated into OFDM signals by an OFDM signal generator 1424 and then transmitted.

The scheduler 1404 can determine whether any data is received on the UL CC as indicated in the scheduling information transmitted to the UE. If the data is received on the UL CC as indicated in the scheduling information, the scheduler 1404 recognizes that the UE has activated the DL CC associated with the UL CC. Otherwise, if no data is received from the UE, the scheduler 1404 controls such that the scheduling information is retransmitted to the UE.

The scheduler 1404 can also configure DCI to instruct the UE to report CQI. The scheduler 1404 can receive CQI report transmitted by the UE and determine the transport format of the DL CC using the received CQI.

Also, the scheduler 1404 can receive the CQI transmitted by the UE and determine the DL CC for transmitting the DL control channel between the DL CC on which the UL scheduling information is transmitted and the DL CC associated with the UL CC. The scheduler 1040 also can control to transmit the DL control channel to the UE on the selected DL CC.

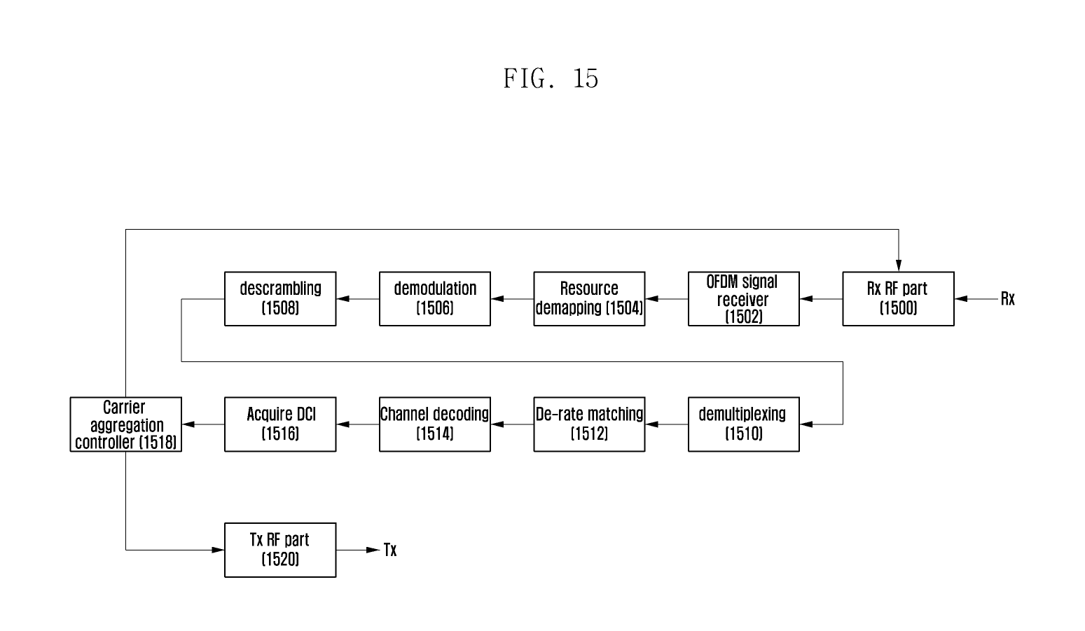

FIG. 15 is a block diagram illustrating UE according to an embodiment of the present invention.

Referring to FIG. 15, the UE receives a signal transmitted by the BS through a receive (Rx) RF part 1500. Thereafter, an OFDM signal processor 1502 performs OFDM signal processing on the signal, a resource demapper 1504 extracts PDCCH from the signal, a demodulator 1506 performs, and a descrambler 1508 descrambles. Thereafter, a demultiplexer 1510 extracts the PDCCH assigned to the UE itself. A de-rate matcher 1512 performs de-rate matching on the PDCCH and a channel decoder 1514 channel decodes and a DCI extractor 1516 acquires the DL control information, i.e., DCI, including the UL scheduling information. The DCI acquired for the received signal is provided to the carrier aggregation controller 1518 of the UE.

The carrier aggregation controller 1518 determines whether the DL CC associated with the UL CC is activated. If the DL CC is deactivated, the carrier aggregation controller 1518 activates the DL CC associated with the UL CC and controls the transmit RF part 1520. Otherwise, if the DL CC is activated, the carrier aggregation controller 1518 restarts the deactivation timer of the DL CC.

The carrier aggregation controller 1518 also controls to measure the path loss value of the activated DL CC. The carrier aggregation controller 1518 also controls to transmit the UL data to the BS according to the transmit power determined based on the measured path loss value.

The carrier aggregation controller 1518 can control to measure the channel quality indicator of the activated DL CC. The carrier aggregation controller 1518 also can control to transmit the UL data and measured channel quality indicator to the BS on the UL CC according to the UL scheduling information. The UE receives the DL data on the DL CC associated with the UL CC.

The carrier aggregation controller 1518 can also control to receive the DL control channel on one of the DL CC on which the UL scheduling information is received or the DL CC associated with the UL CC.

As described above, a CC activation method and apparatus for a wireless communication system supporting carrier aggregation for broadband transmission allow a UE to more accurately calculate an initial transmit power of data channel to be transmitted on a UL CC, allow a BS to more quickly and accurately perform scheduling on an immediately activated DL CC, and improve the effect of distributing DL control channels across several DL CCs.

Although certain embodiments of the present invention have been described in detail hereinabove, it should be clearly understood that many variations and/or modifications of the basic inventive concepts herein taught which may appear to those skilled in the present art will still fall within the spirit and scope of the present invention, as defined in the appended claims and their equivalents.

What is claimed is:

1. A Component Carrier (CC) activation method for a terminal in a mobile communication system supporting carrier aggregation for broadband service, the method comprising:
receiving, from a Base Station (BS), UpLink (UL) scheduling information for a UL CC in a deactivated state;
determining whether a DownLink (DL) CC associated with the UL CC is activated; and
activating the DL CC, when the DL CC is not activated.

2. The CC activation method of claim 1, further comprising restarting a deactivation timer of the DL CC, when the DL CC is activated.

3. The CC activation method of claim 1, further comprising:
measuring a path loss value of the activated DL CC; and
transmitting UL data to the BS according to a transmit power determined based on the measured path loss value.

4. The CC activation method of claim 1, further comprising:
measuring a channel quality indicator of the activated UL CC; and
transmitting DL data and a measured channel quality indicator to the BS on the UL CC according to the UL scheduling information.

5. The CC activation method of claim 4, further comprising receiving the DL data on the DL CC associated with the UL CC.

6. The CC activation method of claim 5, further comprising receiving a DL control channel on one of a DL CC on which the UL scheduling information is received and the DL CC associated with the UL CC.

7. The CC activation method of claim 4, further comprising:
measuring a channel quality indicator of the activated DL CC and activating a deactivation timer for the DL CC, when the DL CC is activated; and
transmitting the DL data and the measured channel quality indicator of the activated DL CC on the UL CC according to the UL scheduling information.

8. A control signal transmission method for a Base Station (BS) for activating a Component Carrier (CC) for a terminal in a mobile communication system supporting carrier aggregation for broadband service, the method comprising:
transmitting UpLink (UL) scheduling information for a UL CC in a deactivated state to the terminal;
determining whether data is received from the terminal on the UL CC according to the scheduling information; and
recognizing that the terminal has activated the UL CC associated with the UL CC, when the data is received.

9. The control signal transmission method of claim 8, further comprising retransmitting the UL scheduling data, when the data is not received.

10. The control signal transmission method of claim 8, wherein transmitting the UL scheduling information comprises:
generating a command instructing the terminal to measure and report a channel quality indicator of a DownLink (DL) CC associated with the UL CC; and
transmitting the scheduling information including the command to the terminal.

11. The control signal transmission method of claim 10, wherein determining whether the data is received from the terminal comprises:
checking whether a channel quality indicator measured by the terminal for the UL CC is received; and
selecting a transport format of the DL CC using the channel quality indicator, when the channel quality indicator is received.

12. The control signal transmission method of claim 11, further comprising:
selecting one of the DL CC on which the UL scheduling information has been transmitted and the DL CC associated with the UL CC based on the received channel quality indicator for transmitting the DL control channel; and
transmitting the DL control channel on the selected DL CC.

13. A terminal for activating a Component Carrier (CC) in a mobile communication system supporting carrier aggregation for broadband service, the terminal comprising:
a Radio Frequency (RF) receiver that receives UpLink (UL) scheduling information for a UL CC in a deactivated state from a Base Station (BS); and
a carrier aggregation controller that determines, based on the UL scheduling information, whether a DownLink (DL) CC associated with the UL CC is activated, and activates the DL CC, when the DL CC is not activated.

14. The terminal of claim 13, wherein the carrier aggregation controller restarts a deactivation timer of the DL CC, when the DL CC is activated.

15. The terminal of claim 13, wherein the carrier aggregation controller measures a path loss value of the activated DL CC and transmits UL data according to a transmit power determined using a measured path loss value.

16. The terminal of claim 13, wherein the carrier aggregation controller measures a channel quality indicator of the activated DL CC and transmits UL data and a measured channel quality indicator on the UL CC according to the UL scheduling information.

17. The terminal of claim 16, wherein the carrier aggregation controller receives a DL control channel on one of a DL CC on which the UL scheduling information is received and the DL CC associated with the UL CC.

18. A Base Station (BS) for transmitting a control signal for activating a Component Carrier (CC) for a terminal in a mobile communication system supporting carrier aggregation for broadband service, the BS comprising:
a carrier aggregation controller that determines whether to aggregate UpLink (UL) CCs or DL CCs; and
a scheduler that generates UL scheduling information on an UL CC in a deactivated state, transmits the UL scheduling information to the terminal, determines whether data is received from the terminal on the UL CC as indicated in the scheduling information, recognizes that the UE has activated a DownLink (DL) CC associated with the UL CC, when data is received, and retransmits the UL scheduling information to the terminal, when data is not received.

19. The BS of claim 18, wherein the scheduler generates a command instructing the terminal to measure and report a channel quality indicator of the DL CC associated with the UL CC.

20. The BS of claim 19, wherein the scheduler receives the channel quality indicator transmitted by the terminal, selects one of a DL CC on which the UL scheduling information has been transmitted and the DL CC associated with the UL CC based on the channel quality indicator, for transmitting the DL control channel, and transmits the DL control channel on the selected DL CC to the terminal.
